(19) United States
(12) Patent Application Publication
(10) Pub. No.: US 2003/0136048 A1
(43) Pub. Date: Jul. 24, 2003

(54) Weed killing apparatus and method

(76) Inventor: Richard John Newson, Have lock North (NZ)

Correspondence Address: DANN DORFMAN HERRELL & SKILLMAN, SUITE 720, 1601 MARKET STREET, PHILADELPHIA, PA, 19103-2307, US

(21) Appl. No.: 10/373,369

(22) Filed: Feb. 24, 2003

Related U.S. Application Data
(63) Continuation of application No. 09/890,038, filed on Oct. 30, 2001, now abandoned.
Application No. 09/890,038 is a 371 of international application No. PCT/NZ99/00011, filed on Jan. 29, 1999.

(51) Int. Cl. A01G 7/04; A01C 1/00

(52) U.S. Cl. 47/1.3

(57) ABSTRACT

A weed killing apparatus comprises an application head at one end of the apparatus and a handle at another end of the apparatus by which a user standing on the ground may move the application head over a weed or weeds in the ground. The application head is heated and has at least one steam outlet in or adjacent the application head. Steam producing means is arranged to produce steam and is controllable by the user to direct steam from the steam outlets when the application head is placed over a weed or weeds, so that the weed(s) is/are killed by a combination of heat from the application head and steam. A method of killing or controlling weeds comprises applying the heated application head over the weed(s) to heat the weed(s) through direct physical contact or radiant heating from the application head while simultaneously directing stem from the application head on to the weed(s).

### FIELD OF INVENTION

The invention comprises a weed killing apparatus and method.

### BACKGROUND OF INVENTION

Conventionally weeds are controlled by pulling out the weeds or by use of chemical sprays, which are extensively used in various areas and applications including in domestic applications for killing for example broadleaf weeds in lawns, weeds growing in or through paving or similar. Apparatus for killing weeds using hot air or hot water have previously been proposed and are to some extent in commercial use particularly by municipal bodies such as city councils for controlling weeds along roadsides and similar. There is an interest in such systems because of the growing awareness of the side effects which may arise from use of chemical sprays.

There are a number of prior patents/applications internationally relating to weed killing apparatus using hot air or hot water. Examples are New Zealand patent specification 264258 which relates to apparatus for killing weeds using hot water, and PCT patent application WO91/14363 and UK patent application 2,278,988 which relate to apparatus for killing weeds using hot air, which are intended to be hand held by an operator and may be suitable for domestic or similar use.

### SUMMARY OF INVENTION

The invention provides an improved or at least alternative form of weed killing apparatus and method.

In broad terms in one aspect the invention comprises a weed killing apparatus comprising an application head and heating means to heat the application head whereby the apparatus may be used to position the application head over a weed or weeds to apply heat to the weed(s), and at least one steam outlet from or adjacent application head and means arranged to direct steam from the steam outlet(s) onto the weed(s) when the application head is positioned over the weed(s).

Preferably the apparatus of the invention is configured for use by a single operator or user standing on the ground, and has a handle or handles at one upper end by which a user may hold the apparatus and move the application head which is positioned at the lower end of the apparatus, over weeds in the ground. The apparatus comprises means to heat the application head and means to produce steam within the body of the apparatus, and a trigger or other manually operable means by which the user may cause ejection of steam from outlet(s) through or adjacent the application head.

In broad terms in another aspect the invention comprises a method of killing or controlling weeds comprising applying a heated application head over the weed(s) to heat the weed(s) through direct physical contact or radiant heating from the application head while simultaneously directing steam from the application head on to the weed(s).

With the apparatus and method of the invention weeds are killed through a combination of heat applied by a heated application head which is placed against the weed in physical contact with the weed and may be pressed against the weed, or which is positioned if not in physical contact with the weed then immediately above the weed in the ground, and steam which is ejected from outlets in or adjacent the application head. Weeds are killed through heat applied by the application head combined with a shot or burst of steam. This is in contrast to apparatus and methods in the prior art, based on hot water which consumes energy in heating of significant quantities of water, and hot air with which there is a danger of igniting the foliage of the weeds after it has been dried by initial contact with the hot air.

### BRIEF DESCRIPTION OF THE DRAWINGS

Preferred forms of weed killing apparatus of the invention are described with reference to the accompanying drawings, by way of example and without intending to be limiting. In the drawings:

FIG. 1 shows a first preferred form apparatus in use;

FIG. 2 shows the first preferred form apparatus side on;

FIG. 3 is a cross-sectional view through the first preferred form apparatus;

FIG. 4 is a cross-sectional view through another preferred form apparatus;

FIG. 5 is a view of a roller-type preferred form apparatus; and

FIG. 6 is a side view of the roller-type apparatus of FIG. 5.

### DETAILED DESCRIPTION OF PREFERRED FORMS

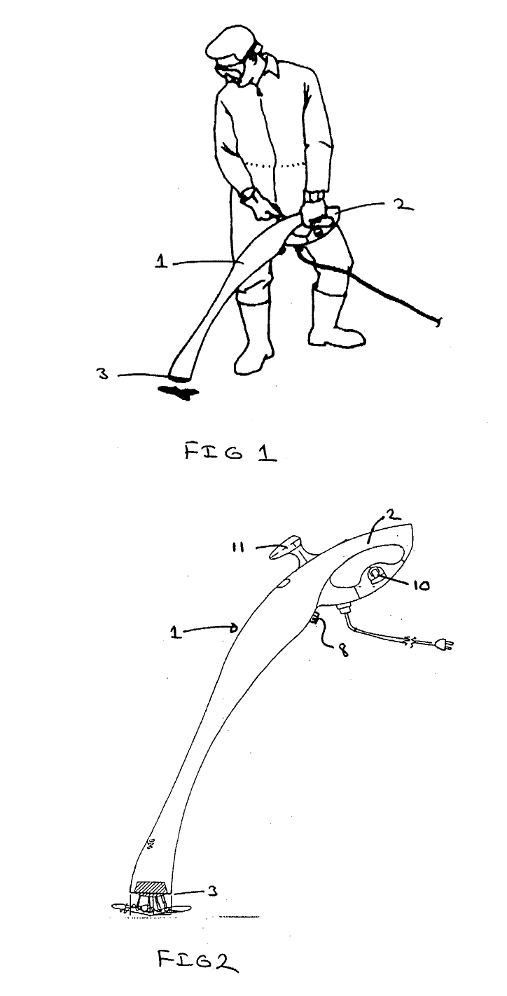

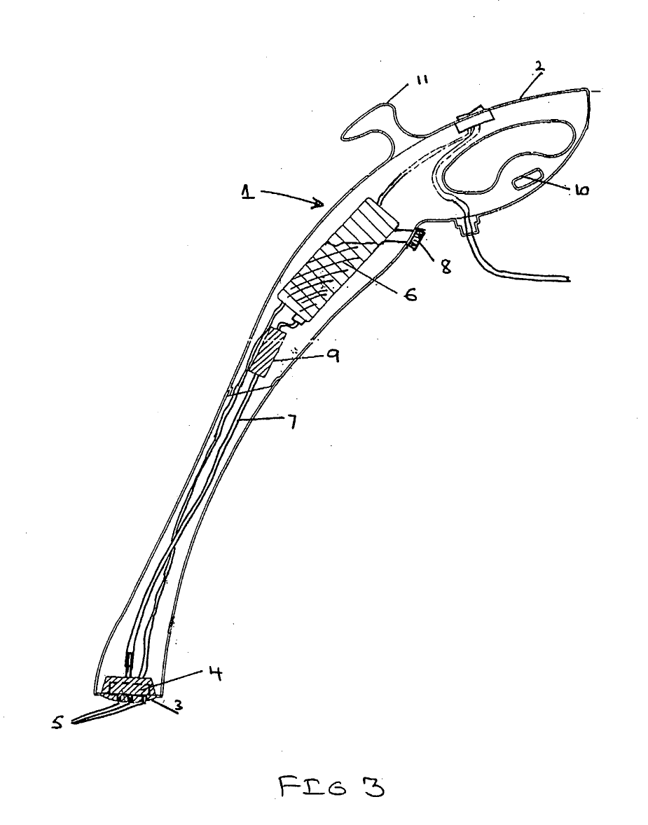

The preferred form apparatus shown in FIGS. 1 to 3 is intended for domestic or at least individual operator use, by a user standing on the ground and walking over the ground carrying the apparatus. The apparatus has a handle at one upper end and an application head at its other lower end. The preferred form apparatus is electrically powered and in a domestic application would be connected to the mains supply in a house or out building via an extension cord in the same way as electric line trimmers are used for example. The invention is not limited to such individual user operated apparatus however as will be referred to further.

Referring to FIGS. 1 to 3, the apparatus comprises a body generally indicated at 1 having a handle 2 at one end, and an application head 3 at a lower end. The body 1 of the apparatus may be moulded in two halves from a plastics material and has a hollow interior within which other components of the apparatus are mounted as will be described, but alternatively the apparatus could be otherwise formed, with the components thereof attached for example to a central shaft rather than being housed within the interior of a hollow body.

In the preferred form the applicator head comprises a component form from metal for example by pressure die casting. The preferred form applicator head has an internal cavity 4, into which shots of water are directed to be heated to steam within this cavity 4 in the applicator head in use of the apparatus. A number of bores 5 from the internal cavity 4 to the external face of the applicator head 3 form steam outlets from which steam formed in the cavity is directed in use. The applicator head also comprises an integral electrical resistance heating element (not shown) arranged to heat the applicator head and surrounding the steam forming cavity 4 to heat the interior of the cavity to above 100° C.

A water reservoir 6 is mounted within the interior of the hollow body of the apparatus and is connected to the application head and in particular to the steam cavity 4 therein, by conduit 7. The reservoir may be replenished with water via an inlet spout which is accessed from the exterior of the apparatus by removal of screw cap 8. The top of the reservoir 6 is suitably vented to allow air to enter the reservoir as the water level therein reduces.

In the preferred form a small pump 9 is positioned between the reservoir 6 and the application head 3. The pump is controlled by a trigger 10 associated with the handle of the apparatus. In the preferred form shown the pump 9 is mechanically operated and is connected to the trigger 10 via a wire rod. Operation of the trigger 10 causes the pump 9 to deliver a quantity of water from the reservoir 6 into the steam cavity within the application head 31, over conduit 7. In use the shot of water is rapidly heated and turned to steam which exits the outlets 5 in the application head, so that operation of the trigger 10 rapidly causes the ejection of a shot of steam from the application head 3 of the apparatus. The pump could alternatively be electrically operated by a small motor or solenoid, controlled by the trigger 10. Alternatively delivery of steam from the application head may be controlled by a button in the handle of the apparatus, or other means manually operable by the user.

The preferred form apparatus also comprises a second handle 11 on the top of the upper end of the apparatus as shown.

In use a user holds the apparatus via the handles 10 and 11 and moves the apparatus to position the application head 3 over a weed in the ground (including on paving or similar). The user may press the hot application head 3 against the weed or at least part of the foliage of the weed. Simultaneously the user operates the trigger 10 or equivalent to direct a shot of steam from the application head against the weed. It is necessary to apply the apparatus to the weed for only a few seconds. The weed is killed by the combination of heat from the application head and steam, and will “brown off” subsequently.

In the preferred form apparatus described above steam is created by delivering water into the heated cavity 4 within the application head, from which steam exits through the outlets 5. Other arrangements are possible however, such as the heating of water to steam via a separate electrical heating element surrounding a separate chamber in which water is heated, or a part of the conduit connecting the reservoir to the application head so that water passing through the conduit is boiled en route to the steam outlets from the application head. Also, instead of being ejected from outlets through the application head, a steam outlet may be positioned adjacent the application head and for example a series of steam outlets may be positioned around the heated part of the application head 3. The appliance instead of being electrically powered may comprise a gas burner to heat the application head, and to create steam. The appliance may be accompanied by a small gas bottle connected to the appliance via a connecting hose.

The preferred form apparatus uses a pump to deliver water to the application head to be heated to steam but alternatively the apparatus may rely on gravity feed controlled by a valve mechanically or electrically operated via the trigger 10 or equivalent, at the handle of the apparatus.

In the preferred form the application head has a convex exterior surface but alternatively it may be flat or irregular such as rippled or corrugated for example. A small shroud may surround the application head to contain the heat and steam while the application head is pressed against a weed in the ground. One or more small wheels or skids may also be provided at either side of or to the rear of the application head.

The preferred form apparatus of FIGS. 1 to 3 is suitable for domestic use, or other single operator use for example for “spot” killing of weeds in sports grounds, pavements etc, but apparatus of the invention utilising a heated application head in combination with the simultaneous direction of steam onto the weeds is possible. FIG. 4 shows an application head in the form of a plate 11 which may be rectangular in shape and may be mounted to the front or rear of the four wheel all terrain vehicle by a bracket 12 and a small hydraulic ram (not shown) enabling the application head 11 to be raised and lowered in the direction of arrow A in FIG. 4 by an operator. The application head 11 has an internal cavity 13. The application head is heated by an embedded electrical resistance element which is powered from the ATV. Water from a tank mounted on the ATV is conducted to the application head 11 over pipe 15 which connects to the application head via coupling 16 incorporating a small orifice or valve so that water will drip into the cavity 13. Steam is formed in the cavity 13 and exits the outlets 14 in the bottom of the plate. In use, the rider of the ATV stops at an area of weeds and operates the hydraulic ram to lower the application head over the weeds for a few seconds. The application head is formed with a peripheral skirt 17 as shown.

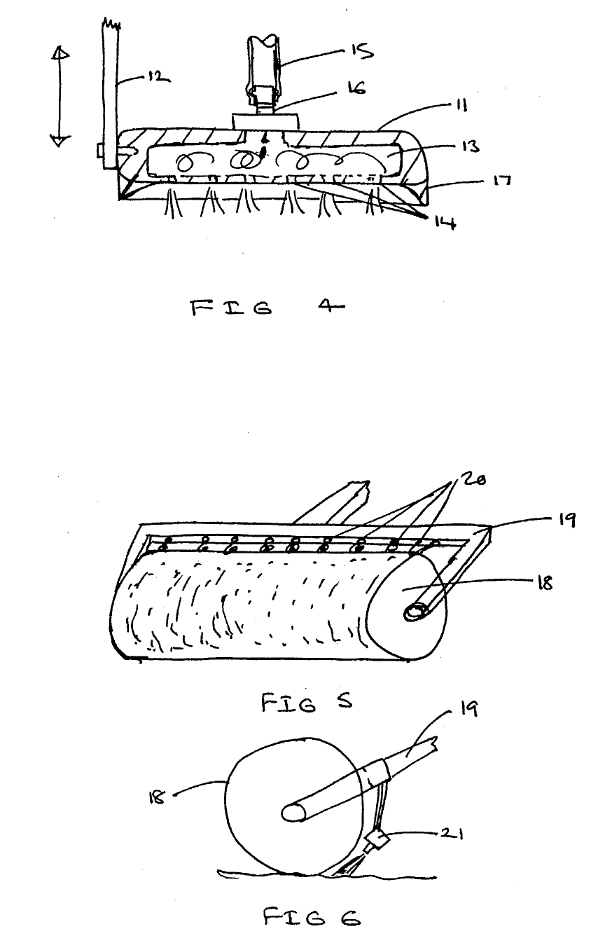

FIGS. 5 and 6 show a large roller 18 mounted in towing frame 19 and intended to be towed over the ground and having a heated exterior surface. As the roller moves steam is ejected through perforations in the exterior surface of the roller. The roller may be heated by an electrical resistance element embedded below the surface of the roller, or alternatively may be heated by a line of small gas burners 20 contacting the surface of the roller behind the roller for example. Steam, produced at a remote boiler, is ejected from a row of nozzles/outlets 21 onto the ground immediately in front of the roller 18.

Other similar arrangements are possible utilising the central concept of the invention which is the simultaneous application of a heated application head and steam to kill weeds.

The foregoing describes the invention including preferred forms thereof. Alterations and modifications as will be obvious to those skilled in the art are intended to be incorporated within the scope hereof, as defined in the accompanying claims.

What is claimed is:

1. A weed killing apparatus comprising an application head and heating means to heat the application head whereby the apparatus may be used to position the heated application head over a weed or weeds to apply heat to the weed(s), and at least one steam outlet from or adjacent the application head and means arranged to direct steam from the steam outlet(s) onto the weed(s) when the application head is positioned over the weed(s).

2. A weed killing apparatus comprising an application head at one end of the apparatus and a handle at another end of the apparatus by which a user standing on the ground may move the application head over a weed or weeds in the ground, heating means to heat the application head and at least one steam outlet in or adjacent the application head, and steam producing means arranged to produce steam and controllable by the user to direct steam from the steam outlets when the application head is placed over a weed or weeds, so that the weed(s) is/are killed by a combination of heat from the application head and steam.

3. A weed killing apparatus according to claim 2 comprising a trigger or other manually operable means associated with the handle of the apparatus by which a user may control the ejection of steam from the apparatus.

4. A weed killing apparatus according to claim 3 comprising a refillable reservoir within a body of the apparatus for water from which steam is produced.

5. A weed killing apparatus according to claim 4 including a pump or valve means controlled by the trigger or manually operable means associated with the handle, arranged to pump or release a controlled quantity of water from the reservoir on each operation of the trigger or manually operable means, to produce steam.

6. A weed killing apparatus according to any one of claims 2 to 5 wherein the application head comprises a cavity within the application head in which water is heated to steam and from which steam passes through said steam outlets from the application head.

7. A weed killing apparatus according to claim 6 when dependent on claim 5 wherein each operation of the trigger or manually operable means associated with the handle pumps or releases a controlled quantity of water into said cavity in the application head via a connecting conduit from the water reservoir in the apparatus.

8. A weed killing apparatus according to claims 1-5 and 7 arranged to be connected to a source of electrical power and wherein the application head is heated by an electrical resistance element.

9. A weed killing apparatus according to claims 1-5 and 7 wherein an exterior face of the application head is convex in shape.

10. A method of killing or controlling weeds comprising applying a heated application head over the weed(s) to heat the weed(s) through direct physical contact or radiant heating from the application head while simultaneously directing steam from the application head on to the weed(s).

11. A weed killing apparatus according to claim 6 arranged to be connected to a source of electrical power and wherein the application head is heated by an electrical resistance element.

12. A weed killing apparatus according to claim 6 wherein an exterior face of the application head in convex in shape.
